(19) United States
(12) Patent Application Publication
(10) Pub. No.: US 2009/0245047 A1
(43) Pub. Date: Oct. 1, 2009

(54) METHOD OF ENCODING DATA ON AN INFORMATION CARRIER, SYSTEM FOR READING SUCH AN INFORMATION CARRIER

(75) Inventors: Robert F.M. Hendriks, Eindhoven (NL); Levinus P. Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,376

(22) PCT Filed: Dec. 13, 2005
(86) PCT No.: PCT/IB05/54199

§ 371 Date: Jun. 11, 2007

(30) Foreign Application Priority Data
Dec. 16, 2004 (EP) 04300906.7

(51) Int. Cl. G11B 20/00; G11B 7/24; G11B 7/00

(52) U.S. Cl. 369/47.19; 369/275.1; 369/100; G9B/20; G9B/7; G9B/7.139

(57) ABSTRACT

The invention relates to a method of encoding a set of data on an information carrier comprising data areas each intended to store a data, each data area being characterized by a transmission coefficient and a phase-shift coefficient, said method comprising a step of calculating the transmission coefficient and phase-shift coefficient of said data areas so that an output light pattern corresponding to the intensity pattern of said set of data is generated at a given distance from the information carrier, via interference between light outputted by said data areas in response of an array of light spots periodically applied to non-adjacent data areas.

### FIELD OF THE INVENTION

The invention relates to a method of encoding data on an information carrier, and to a system for reading such an information carrier.

The invention may be used in the field of optical storage.

### BACKGROUND OF THE INVENTION

The use of optical storage solutions is nowadays widespread for content distribution, for example in storage systems based on the DVD (Digital Versatile Disc) standards. Optical storage has a big advantage over hard-disc and solid-state storage in that the information carrier are easy and cheap to replicate.

However, due to the large amount of moving elements in the drives, known applications using optical storage solutions are not robust to shocks when performing read/write operations, considering the required stability of said moving elements during such operations. As a consequence, optical storage solutions cannot easily and efficiently be used in applications, which are subject to shocks, such as in portable devices.

Recently, optical storage solutions have thus been developed. These solutions combine the advantages of optical storage in that a cheap and removable information carrier is used, and the advantages of solid-state storage in that the information carrier is still and that its reading requires a limited number of moving elements.

FIG. 1 depicts a three-dimensional view of a system illustrating such an optical storage solution.

This system comprises an information carrier 101. The information carrier comprises a set of data areas having size referred to as s and arranged as in a matrix. Data are coded on each data area via the use of a material intended to take different trnsparency levels, for example two levels in using a material being transparent or non-transparent for coding a 2-states data, or more generally N transparency levels (for example N being an integer power of 2 for coding a ² log(N)-states data).

This system also comprises an optical element 102 for generating an array of light spots 103 which are intended to be applied to said data areas. The optical element 102 may correspond to a two-dimensional array of micro-lenses depicted in FIG. 2, at the input of which the coherent input light beam 105 is applied.

Advantageously, each light spot is intended to be successively applied to a sub-set of data areas (the sub-set being formed in this example by a block of 4*4 data areas), in using an actuator in charge of two-dimensionally translating the optical element 102 so as to translate all the light spots simultaneously over the different sub-set of data areas. According to the transparency state of the data areas to which are applied the light spots, the light spots are transmitted (not at all, partially or fully) to a CMOS or CCD detector 104 comprising pixels intended to convert the received light signal, so as to recover the corresponding data stored on said data areas.

In this known system, data stored on the information carrier are self-imaged on the detector, meaning that the pattern formed by the transparent and non-transparent data areas is reproduced identically on the detector.

Using self-imaging however has technical limitations.

Indeed, since light beams generated by each data area rapidly diverge, self-imaging is not perfect at the detector's, resulting in data-crosstalk and to errors in the data recovery. Data-crosstalk could be slightly attenuated in reducing the distance between the from the information carrier and the detector, but this would add strong mechanical constraints on the design of such a system.

### OBJECT AND SUMMARY OF THE INVENTION

It is an object of the invention to propose a method of encoding data on an information carrier comprising data areas each intended to store a data, each data area being characterized by a transmission coefficient and a phase-shift coefficient, said method allowing an easy, robust and cost-effective data recovery.

To this end, the method of encoding according to the invention comprises a step of calculating the transmission coefficient and phase-shift coefficient of said data areas so that an output light pattern corresponding to the intensity pattern of said set of data is generated at a given distance from the information carrier, via interference between light outputted by said data areas in response of an array of light spots periodically applied to non-adjacent data areas.

Contrary to the prior art where the data are self-imaged on the detector, the method of encoding according to the invention allows a reconstruction of data via an interference phenomenon, i.e. via diffraction caused by the different data areas forming the information carrier in response of an array of light spots. The problem of data-crosstalk is thus solved.

The pattern which is read on the detector directly corresponds to the pattern formed by data stored on the information carrier. This encoding method is thus cost-effective because no additional and complex processing steps are required.

From an implementation point of view, to recover data, no additional optical imaging elements are required in the reader apparatus between the information carrier and the detector, and the detector can be positioned at any distance from the information carrier, which simplifies the design of a system for reading data encoded according to the invention.

The invention also relates to an information carrier for storing data according to this method.

The invention also relates to a system for reading data from such an information carrier.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts a known system for reading data on an information carrier,

FIG. 2 depicts an array of micro-lenses for generating an array of light spots,

FIG. 3 illustrates the electrical field calculation at the detector generated by the light contribution outputted by a data area of an information carrier encoded according to the invention,

FIG. 4 depicts the structure of an information carrier according to the invention,

FIG. 5 depicts a three-dimensional view of a system for reading data encoded according to the invention and stored on an information carrier,

FIG. 6 shows an example of a recovered set of data previously encoded according to the method of the invention,

FIG. 7 depicts various apparatus comprising a system for reading data from an information carrier according to the invention.

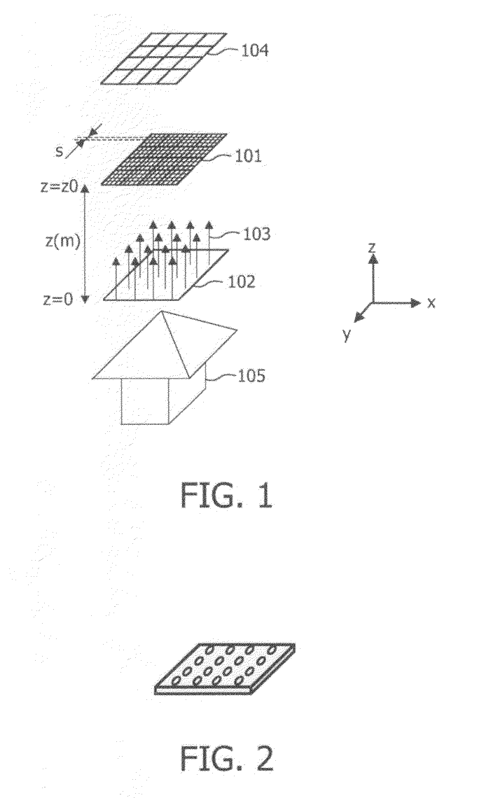

### DETAILED DESCRIPTION OF THE INVENTION

In the following, for sake of understanding, although the invention preferably relates to the encoding of a data set on a two-dimensional information carrier, explanations will be given in considering only a one-dimensional information carrier intended to store a one-dimensional set of data. The skilled person will easily apply the knowledge of a one-dimensional information carrier to a two-dimensional information carrier.

Moreover, although the invention is described based on an information carrier read in transmission, the skilled person will easily apply this knowledge to an information carrier used in reflection (i.e. with reflecting instead of transmitting data areas). In this case, the information carrier further comprises a reflection layer stacked to the data layer.

The method according to the invention relates to the encoding of a set of data on an information carrier. Said information carrier comprises data areas each intended to store a data, each data area being characterized by a transmission coefficient and a phase-shift coefficient. The information carrier thus consists of a phase structure and/or an amplitude structure.

Data are encoded so that an output light pattern corresponding to the intensity pattern of said set of data (i.e. corresponding to the pattern defined by the binary values of data to be stored) is generated at a given distance from the information carrier, via interference between light outputted by said data areas in response of an array of light spots periodically applied to non-adjacent data areas.

The array of light spots may, for example, be generated by an array of apertures as described previously, or an array of micro-lenses. The light applied to the information carrier is coherent, and may correspond to a laser source.

Each light spot is transmitted through a single data area of the information carrier. Each single light spot is successively and simultaneously applied to a data area among a sub-set of data areas (e.g. a sub-set of 4*4 data areas), as described in the background section. In this case, by moving laterally and simultaneously each light spot in front of another data area, another output light pattern is generated by the information carrier, so that the corresponding data can be recovered by the detector.

The data areas can absorb some of the light spots, or add a certain phase-shift to the light spots. The absorption and the phase-shift can be generalized into a complex transmission coefficient tⱼ of a single data area:

tⱼ=\hat{t}ⱼ×e^{iφ}^{ⱼ} (1)

where \hat{t}ⱼ is the transmission coefficient,
φⱼ is the phase-shift caused by data area having rankj.

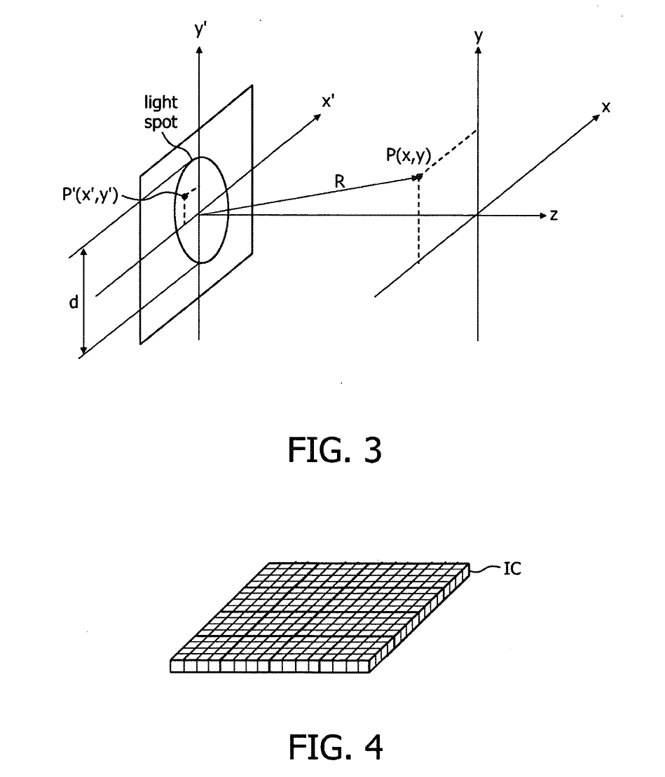

FIG. 3 illustrates by a two-dimensional view, the calculation of the electrical field at point P in the detector plane (x,y), generated by the light contribution outputted at point P′ by a data area of the information carrier situated in plane (x′,y′). For sake of understanding, only one light spot is represented.

In the present case, and for sake of clarity, the diffraction pattern of a single spot is approximated by using Fraunhofer diffiaction, although applying Fresnel diffraction would give a more accurate result. However, this makes the example of the calculations more instructive. The expression for the Fraunhofer diffraction pattern of a single spot can be written as:

$${E}^{′} ( x , z ) ∝ {e}^{i ( ω t - n \cdot {k}_{0} \cdot R )} {\int }_{- d / 2}^{d / 2} {e}^{i \cdot n \cdot {k}_{0} \cdot \frac{{xx}^{′}}{R}} d {x}^{′} \\ {E}^{′} ( x , z ) ∝ {e}^{i ( ω t - n \cdot {k}_{0} \cdot R )} sin c ( n \cdot {k}_{0} \cdot \frac{xd}{2 R} ) \qquad ( 2 )$$

where
∝ means “proportional to”,
x′ corresponds to the lateral position on the information carrier,
x corresponds to the lateral position on the detector,
z corresponds to the vertical position, z=0 being the focal plane of the spots,
ω correspond to the frequency of the input light,
d corresponds to the diameter of the spot,
R corresponds to the distance from point (x′,y′)=(0,0) to point (x,y),
n corresponds to the index of refraction of the material forming the data area,
k₀ corresponds to the length of the wave vector in the vacuum (i.e. k₀=2π/λ₀ where λ₀ is the light wavelength in the vacuum).

Superposing a number of light spots, assuming the electric field is the same for every light spot, results in the following pattern:

$$E ( x , z ) ∝ {\sum }_{j} {E}^{′} ( x , z ) \\ E ( x , z ) ∝ {\sum }_{j} {e}^{i ( ω t - n \cdot {k}_{0} \cdot {R}_{j} )} sin c ( n \cdot {k}_{0} \frac{( x - jp ) d}{2 {R}_{j}} ) \qquad ( 3 )$$

where p is the pitch of the light spots,
j is the rank of the data area,

$$and {R}_{j} = \sqrt{{z}^{2} + {( x - jp )}^{2}} \qquad ( 4 )$$

Introducing the complex transmission coefficient tⱼ results in the following expression:

$$E ( x , z ) ∝ {\sum }_{j} {\hat{t}}_{j} {e}^{i ( ω t - n \cdot {k}_{0} \cdot {R}_{j} + {ϕ}_{j} )} sin c ( n \cdot {k}_{0} \frac{( x - jp ) d}{2 {R}_{j}} ) \qquad ( 5 )$$

If it is chosen to recover data in placing the detector at distance z₀ from the information carrier, the method according to the invention comprises a step of calculating the transmission coefficient and phase-shift coefficient of said data areas by solving the following equation:

|E(x,z₀)|²=K·I(x) (6)

where I(x) corresponds to the intensity pattern of the set of data to be stored on the information carrier,
K is a factor depending on the normalization of both E and I.

Since the phase of the electric field at the detector can have any value (only an intensity measure can be detected by a detector), this equation has a multiple of solutions for every coefficient \hat{t}ⱼ. The encoding can then be optimized to a situation in which the manufacture of the information carrier is facilitated in choosing optimal transmission and phase-shift coefficients. For example, the transmission of the data area can be equally set (i.e. constant absorption, or without any absorption), calculating the phase-shift coefficients accordingly, thus defining an information carrier equivalent as a pure phase profile. In this case, it is very beneficial since a phase profile can easily be embossed, and the amount of transmitted light is maximized.

To solve equation (6), an analytical or numerical approach may be used, such as a least squares fitting performed by a processing unit (e.g. a signal processor executing code instructions stored in a memory).

Advantageously, the method of encoding comprises a step of adding an offset component 10 to the required intensity pattern so that I(x) becomes I(x)+10. Indeed, it is much easier to produce a bit with a certain non-zero intensity, than to produce a bit with zero-intensity. This is due to the fact that zero intensity can be achieved only by a profile, which is zero everywhere in the bit region, while there are a number of profiles that produce a bit with a non-zero intensity.

FIG. 4 illustrates a three-dimensional view of an information carrier IC according to the invention intended to store a set of data.

The information carrier comprises an array of data areas being, for example, square and adjacent, and advantageously organized in subsets (delimited by bold lines).

The data areas are each intended to store a data, each data area being characterized by a transmission coefficient and a phase-shift coefficient so that an output light pattern corresponding to the intensity pattern of said set of data is generated at a given distance from the information carrier, via interference between light outputted by said data areas in response of an array of light spots periodically applied to non-adjacent data areas.

For each data area, the transmission coefficient may be set in varying the transparency factor of the material defining the data area (e.g. plastic). Alternatively, the transmission coefficient may be set by making transparent holes in an absorbing layer. The diameter of the holes determines the absorption. Furthermore, it can be implemented with an absorbing material, where the thickness of the material determines the absorption.

For each data area, the phase-shift coefficient may be set in varying the height of this data area, the height being uniform over the data area. Alternatively, it may be implemented as an index of refraction modulation.

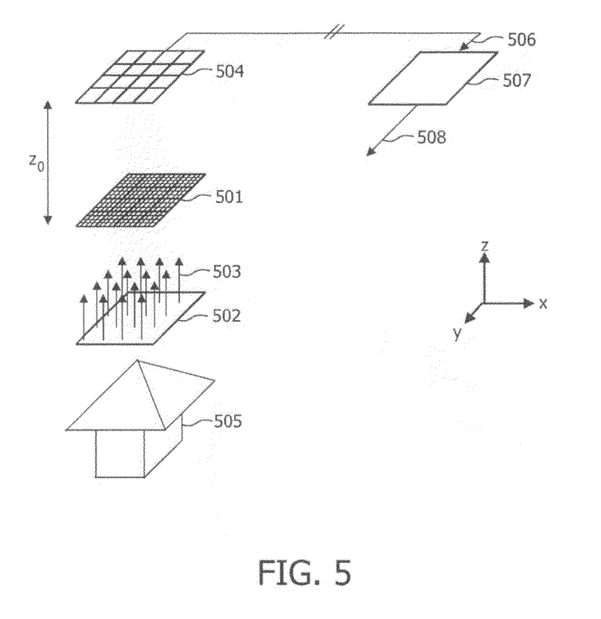

FIG. 5 depicts a three-dimensional view of a system for reading data encoded according to the invention and stored on an information carrier 501.

As previously described in accordance with FIG. 4, the information carrier comprises data areas each intended to store a data characterized by a transmission coefficient and a phase-shift coefficient.

This system also comprises an optical element 502 (e.g. an array of micro-lenses), for generating an array of light spots 503 intended to be applied to said data areas, from an input coherent light beam 505.

Each light spot is intended to be successively applied to a subset of data areas, the subset being formed in this example by a block of 4*4 data areas represented by bold lines, in using an actuator (not shown) in charge of two-dimensionally translating the optical element 502 so as to translate all the light spots simultaneously over the different subsets of data areas. An output light pattern corresponding to the intensity pattern of said set of data is thus generated at a given distance z0 from the information carrier, via interference between light outputted by said data areas in response of an array of light spots periodically applied to non-adjacent data areas.

This system also comprises a CMOS or CCD detector 504 having pixels intended to detect the output light pattern. The pixels of the detector provide electrical signals 506 analysed by a processing unit 507, such as a signal processor executing code instructions of a threshold operation as described previously. In response, the processing unit 507 delivers data 508, corresponding to data stored on the information carrier 501.

In a first implementation, one pixel of the detector faces one subset of data areas.

In a second implementation, at least two pixels of the detector face one subset of data areas. This is beneficial, since the lateral alignment of the information carrier with respect to the detector is less critical.

In a third implementation, one pixel of the detector faces at least two subsets of data areas. This is beneficial, since there is more freedom in finding a solution to (6) for calculating the transmission coefficients.

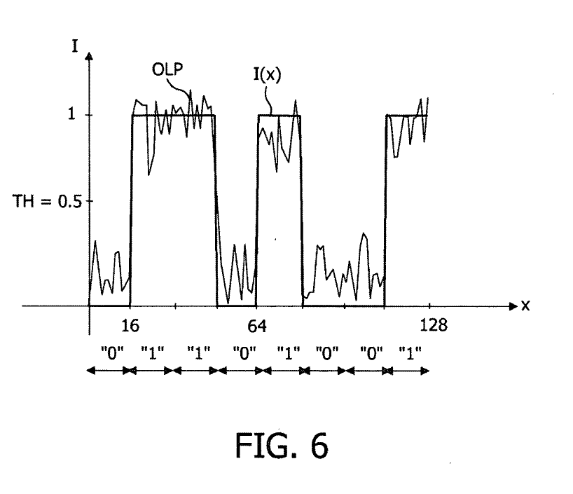

FIG. 6 shows an example of a recovered set of data previously encoded according to the method of the invention, using data areas having complex transmission coefficients as calculated from relation (6), with p=16μ, λ=0.4μ, and z₀=500μ. The set of data to be recovered corresponds to [0,1,1,0,1,0,0,1], and is represented by the intensity pattern I(x).

The output light pattern OLP is generated at a distance z₀ from the information carrier, via interference between said data areas and an array of light spots.

It is apparent that the set of data can be easily recovered from the (normalized) output light pattern OLP, for example via a threshold step working as follows:
parts of the output light pattern OLP being above a given threshold TH (e.g. half the amplitude of the output light pattern OLP) are considered as a “1”,
parts of the output light pattern OLP being below said threshold TH are considered as a “0”.

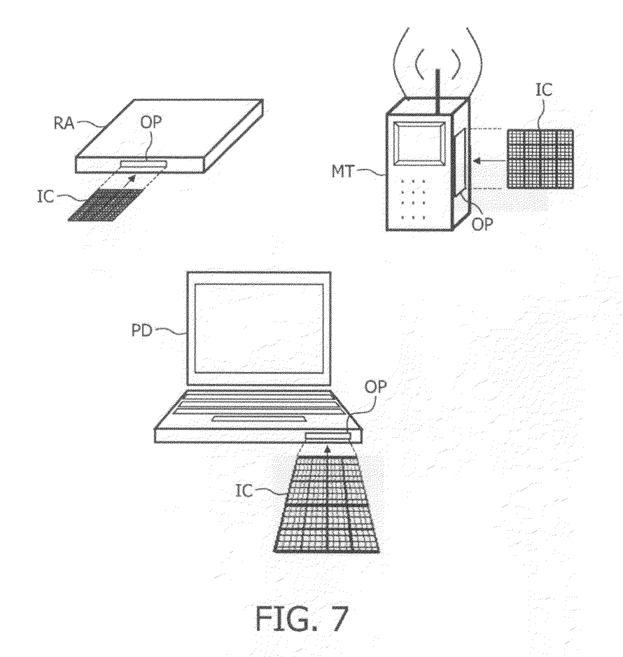

As illustrated in FIG. 7, the system depicted by FIG. 5 may advantageously be implemented in a reading apparatus RA (e.g. home player apparatus . . . ), a portable device PD (e.g. portable digital assistant, portable computer, a game player unit . . . ), or a mobile telephone MT. These apparatus and devices comprise an opening (OP) intended to receive an information carrier IC to which is intended to be applied the array of light spots, in view of for reading/writing data.

Use of the verb “comprise” and its conjugations does not exclude the presence of elements or steps other than those stated in the claims. Use of the article “a” or “an” preceding an element or step does not exclude the presence of a plurality of such elements or steps.

1. A method of encoding a set of data on an information carrier comprising data areas each intended to store a data, each data area being characterized by a transmission coefficient and a phase-shift coefficient, said method comprising a step of calculating the transmission coefficient and phase-shift coefficient of said data areas so that an output light pattern corresponding to the intensity pattern of said set of data is generated at a given distance from the information carrier, via interference between light outputted by said data areas in response of an array of light spots periodically applied to non-adjacent data areas.

2. A method as claimed in claim 1, further comprising a step of adding an offset value to said intensity pattern before determining said transmission coefficient and phase-shift coefficient.

3. An information carrier intended to store a set of data, said information carrier comprising data areas each intended to store a data characterized by a transmission coefficient and a phase-shift coefficient, so that an output light pattern corresponding to the intensity pattern of said set of data is generated at a given distance from the information carrier, via interference between light outputted by said data areas in response of an array of light spots periodically applied to non-adjacent data areas.

4. An information carrier as claimed in claim 3, wherein each data area are formed by a material having different transparency factors linked to the thickness of said data area, or comprising transparent holes of different sizes, for defining said transmission coefficient.

5. An information carrier as claimed in claim 3, wherein each data area are formed by a material having different heights values uniform over its area, or by a material having different indexes of refraction modulation, for defining said phase-shift coefficient.

6. A system for reading data from an information carrier comprising data areas each intended to store a data characterized by a transmission coefficient and a phase-shift coefficient, so that an output light pattern corresponding to the intensity pattern of said set of data is generated at a given distance from the information carrier, via interference between light outputted by said data areas in response of an array of light spots periodically applied to non-adjacent data areas, said system comprising:
an optical element for generating said array of light spots,
a detector placed at said given distance and having pixels intended to detect said output light pattern,
a processing unit executing code instructions of a threshold operation for recovering data from said output light pattern.

7. A portable device comprising a system as claimed in claim 6.

8. A mobile telephone comprising a system as claimed in claim 6.

9. A game player unit comprising a system as claimed in claim 6.
